(19) United States
(12) Patent Application Publication
(10) Pub. No.: US 2026/0225223 A1
(43) Pub. Date: Aug. 6, 2026

(54) MATERIAL SUPPORT PLATFORM FOR POWER TOOLS

(71) Applicant: EZ-WINGS, LLC, Milliken, CO (US)

(72) Inventors: Benjamin A. EARNHART, Milliken, CO (US); Calvin SELLENS, Timnath, CO (US)

(21) Appl. No.: 19/153,078

(22) PCT Filed: Feb. 1, 2024
(86) PCT No.: PCT/US2024/014061

§ 371 Date: Aug. 1, 2025

Related U.S. Application Data
(60) Provisional application No. 63/442,979, filed on Feb. 2, 2023.

(51) Int. Cl. B25H 1/04; B23D 47/02; B25H 1/10

(52) U.S. Cl. CPC B25H 1/04; B25H 1/10; B23D 47/025

(57) ABSTRACT

A universal power tool extension support system can provide a base that is a power tool securably-pairable, compact, extension support system separably itinerant, substantially universal base assembly that may have rail pairs with integral top and side T-slots. The system may include an adjustable presettable support height adjustment element with an extension support at least partially aligning attachment element or elements that can facilitate attaching an independent, individually base attachable-detachable, extension support such as one or more wings and even have additional extension supports or wings.

### TECHNICAL FIELD

This invention relates broadly to accessories for power tools. More particularly, this invention may relate to workpiece-supporting extensions for power saws, miter saws, chop saws, or the like. It also relates to a unique coupling mechanism for rapidly attaching and aligning an item such as an extension to a power tool apparatus or other stand as well as a unique structure allowing for its use on any surface.

Although aspects are applicable to portable power tools in general, for the sake of briefness and simplicity, a power miter saw will generally be the example of one type of portable power tool described in relationship to this invention. This should be understood as but one example; other tools and stands can also be included.

### BACKGROUND

Miter saws are one example of a power tool that may primarily be used for making angled and transverse cuts in building materials. Most miter saws used today may be portable electric powered units which may include a short horizontal material support platform or base with a vertical rear material guide fence and an adjustable circular or other saw affixed to and supported above the material support platform via a hinged arm or the like. The purpose of the material support platform of a miter saw or like tool may be to give the operator a surface on which to rest a board or other type of material to stabilize it while making desired cuts. The need for material support when operating a miter saw cannot be overstated as it may not only be a convenience issue but may also be a safety issue. Improper or inadequate material support can cause injury due to the length of the material being cut and possibly awkward and unsafe positions that the saw user may have to put themselves into in order to make those cuts.

One reason for the wide popularity of power miter saws may be their portability. They are typically lightweight, and therefore easily transported to and from a jobsite. Miter saws and most power tools usually have a pedestal or other such bottom mount with attachment points (often but not necessarily four) through which, if desired but nearly always a safer option, they can be secured.

A miter saw may only be intended to allow the various angles as well as straight cuts to be made accurately. However, the short material support platform of a miter saw may make it difficult to accurately make cuts on long material or other item as the unsupported end of the material not resting on the short material support platform of the miter saw may tend to pull downward under its own weight, and may thus pull the opposite end of the material upward toward the saw blade. To compensate for this effect, the user of the saw often needs to forcefully hold the end of the material to be cut against the platform surface and guide fence of the saw. This can be difficult and dangerous as the user may need to also correctly position the material, hold it firmly in place, and operate the saw at the same time, which can often result in injury to the user.

Since the material support platform of the miter saw is typically short in length, there is often no simple way to incorporate a stop block which would allow for multiple identical cuts to be made. Without a stop block, each piece of material to be cut may need to be individually marked before cutting. This is not only time consuming, but it also leaves room for error in measurement from each individual cut.

Every jobsite is different and the availability of a bench, table or other structural arrangement upon which to place a saw may not be available or convenient. Many users place their power tools on the ground for use, but this does not negate the need for a way to safely and conveniently make the necessary cuts. So, some users may utilize mobile miter stands which can be quite heavy and can take up considerable space during transport and use. Typically, they do not provide full material support. And some can be based on having rollers upon which the material is placed, which may need to be adjusted each time a different material length is introduced or a different size cut is introduced. Often such stands are also not conducive to situations whereby the saw needs to be moved about, or placed on the ground or on some other surface. Some users can fabricate their own stands which are usually not transportable, and may be quite large and heavy. And, of course, miter saws and power tools more generally can come in any different shape and size. Therefore, there is a need for a universal strong, stable, lightweight, easily transported, easily assembled, and easily disassembled material support platform-extension for a miter saw or other tool which can be used on any surface, which mounts directly to the saw, which accommodates substantially any number of different miter saw or power tool sizes and shapes and heights and mounts, which is not limited by its need to utilize any other device, which can also be extended to any length desired, and which allows for the use of any, perhaps tracked (T-Track, Miter Track, Etc.), accessory desired.

Most existing devices are not specifically structured for, nor suitable for use without a matching portable work bench, stand, or support table. They are not truly universal. They also are not structured for a unique and quick assembly and disassembly of the extension wings to a base that is attached to the saw especially in a manner whereby the arrangement can be set once and then easily and quickly assembled and disassembled for that particular power tool. They also do not have the same functionality as aspects and embodiments of the invention which allow for as many extension pieces as desired without any compromise to stability. Even while implementing technologies and features have been available in other contexts, they have not been realized to be applicable as shown here and have not solved desired issues as now achieved. For example, U.S. Pat. No. 4,341,247 discloses an extension table that is supposedly versatile and supposedly simply aligned, but it is not to the degrees of the present system. It apparently did not realize or does not provide a system that uses a separate, compact, easily movable apart from the support system, so called itinerant base to allow a support system that is so easily attached and detached as well as transported as the present system. It does not provide a universal base and system and does not provide such a continuously repositionable power tool connectability as is needed. Further limiting its appeal, there is no presettability so job site assembly can be facilitated as for the present system. U.S. Pat. No. 4,561,336 discloses a workbench that is designed to accept miter saws of any size, but it is a large and cumbersome system. It also does not provide a system that uses a universal, separate, compact, easily movable apart from the support system, so called itinerant base to allow a support system that is so easily attached and detached as well as transported as the present system. It does not provide such a continuously repositionable power tool connectability and there is no base presettable elements so job site assembly can be facilitated as for the present system. U.S. Pat. No. 4,798,113 discloses an extension table where a miter saw is to be mounted on its own base. It does not provide a universal base system and does not provide such a continuously repositionable power tool base connectability, and there is no presettability for job site assembly as for the present system. U.S. Pat. No. 5,038,650 discloses a support and extension that can receive a saw, but it does not provide a practical and transportable support system like the present disclosure. It does not provide a system that uses a universal, separate, compact, easily movable itinerant base to allow a support system that is so easily attached and detached as well as transported as the present system. It does not provide a system with presettability as in the present system so job site assembly can be facilitated to the degree now provided. U.S. Pat. No. 11,554,513 discloses a saw fence with a base, but it does not provide a system that uses a universal, separate, compact, itinerant base to allow a support system that is so easily attached and detached as well as transported as the present system. It does not provide a universal base and system with the continuously repositionable power tool connectability as is needed and there is no presettability so job site assembly can be facilitated as for the present system. U.S. Pat. No. 5,105,862 discloses extensions for a platform but does not provide a universal base system with such a continuously repositionable power tool connectability as is needed and there is no presettability so job site assembly can be facilitated as for the present system. And there are or were miter saw fence extension kits that were available online. These involve (d) an extension table that were supposedly able to be constructed to fit any popular miter/chop saw. But constructing them for a saw it is not what is truly desired. Those products did not realize or did not provide a system that uses a universal, separate, compact, itinerant base to allow a support system that is so easily attached and detached as well as transported as the present system. They did not provide a universal premade system and did not provide such a continuously repositionable power tool connectability as is needed and there was no presettability as in the present system to facilitate job site assembly. Similarly, there are or were saw stand products that were available online. These are/were touted as fence universal systems but they did not provide a system that uses a universal, separate, compact, itinerant base to allow a support system that is so easily attached and detached as well as transported as the present system and did not provide such a continuously repositionable power tool connectability as is needed. And even other attempts have been made such as U.S. Pat. Nos. 4,677,920, 4,817,693, 4,860,807, and 4,874,025, however none of these provide systems with the universal, separate, compact, itinerant base as here to allow a support system that is so easily attached and detached as well as transported as the present system. Accordingly, a need for a system with the features mentioned has remained and these needs, among others, are what is satisfied by the present systems.

### BRIEF DESCRIPTION OF THE DRAWINGS

FIG. 1 is an exemplary drawing of a full assembly according to one embodiment of the invention.

FIG. 2 is an exemplary drawing of a base assembly.

FIG. 3 is an exemplary drawing of a wing and extension assembly.

FIG. 4 is an exemplary drawing of a full assembly with one extension.

FIG. 5 is an exemplary drawing of a saw with a base assembly.

FIG. 6 is an exemplary drawing of a wing assembly.

### DISCLOSURE

It should be understood that embodiments include a variety of aspects, which may be combined in different ways and applied to different power tools, a miter saw being but one example. The following descriptions are provided to list elements and describe some of the embodiments of the application. These elements are listed with initial miter saw-type embodiments; however, it should be understood that they may be used with other power tools, and may be combined in any manner and in any number to create additional embodiments.

The variously described examples and preferred embodiments should not be construed to limit the embodiments of the application to only the explicitly described systems, techniques, and applications. The specific embodiment or embodiments shown are examples only. The specification should be understood and is intended as supporting broad claims as well as each embodiment, and even claims where other embodiments may be excluded. Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

### MODES FOR CARRYING OUT AND PREFERRED EMBODIMENTS

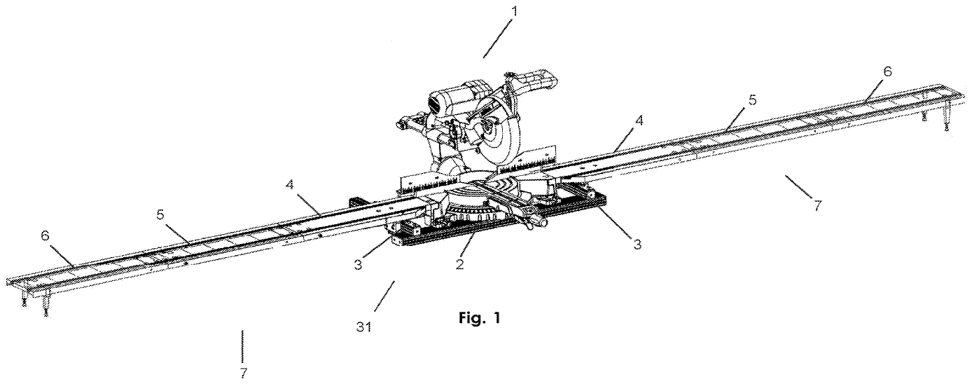

As can be appreciated from the assembly shown of FIG. 1, embodiments can present a universal power tool extension support system (31) and a method of universally providing an extension support for a power tool, as well as more generally, a universal power tool accessory mount (2) and a method of universally providing a power tool accessory. Embodiments may include a light weight, easily transportable, space saving accessory device or system that can allow material to be fully supported while using power tools or the like. As mentioned, examples are primarily focused on miter saws and chop saws, but could include other benchtop power tools such as surface planers, table saws, router tables, jointers, or other. Embodiments may include a support platform that can connect to a power tool via an adjustable base that can fit to substantially any size saw or other tool which may also allow for a quick connect and disconnect of the material support platform extension arms perhaps via unique sliding brackets, such as T-slot L-Brackets described.

In FIG. 1, one embodiment is shown presenting a universal power tool extension support system (31) and a method of universally providing an extension support for a power tool. Embodiments can allow for at least one independent, individually base attachable-detachable, extension support (4) configured to be detachably attached to perhaps a power tool securably-pairable, compact, extension support system separably itinerant, substantially universal base assembly (2). From a process or method perspective, this can accomplish the steps of detachably attaching at least one independent, individually base attachable-detachable, extension support to a power tool securably-pairable, compact, extension support system separably itinerant, substantially universal base assembly. Several aspects of this should be noted. The base (2) may be power tool securably-pairable. For this, it can be attachable to the power tool (1) in a secure fashion so the base (2) can remain on the power tool even though the supports may be removed. This can aid in transportation where the base and power tool combination can remain attached and be moved from one use location to another as a pair. The base (2) may also be compact in that it does not significantly extend beyond the external limits of the power tool (1) as shown with a balance of its size being such that the base (2) remains substantially universal, so that it can be used with an appreciable number of different power tools by even different manufacturers. It may not fit all, but it could fit an appreciable number so that perhaps the top few or several of a particular type of power tool (e.g., miter saw, etc.) can be accommodated by the elements of the base and its element sizing that makes of the base's external dimensions. In addition, the base (2) may be separably itinerant. This allows the base (2) to be moved about and, of course, transported from job site to job site, on its own as securably-paired with the power tool likely apart from any attached extension support (4). As mentioned above, this feature is a significant aspect that makes the present designs commercially desireable. As shown, the extension support (4) can be at least one base attachable-detachable material support wing (4) and there may be other support wings as shown (5, 6) and even others by just adding another such wing or the like. Thus, by detachably attaching one or any number of general extension supports (4, 5, 6), or as shown, wings (4, 5, 6) on one side or both of the power tool (1), the system can provide versatility in supporting almost any workpiece. As shown in the figures, extension arms (4, 5, 6) or otherwise can be connected and can be extended by adding extension pieces to make the support platform arm or arms a desired length. These extension arms (4, 5, 6) can have adjustable length legs (10) to support those extensions on any surface, and that can fold flat when not in use as can be understood from FIG. 1.

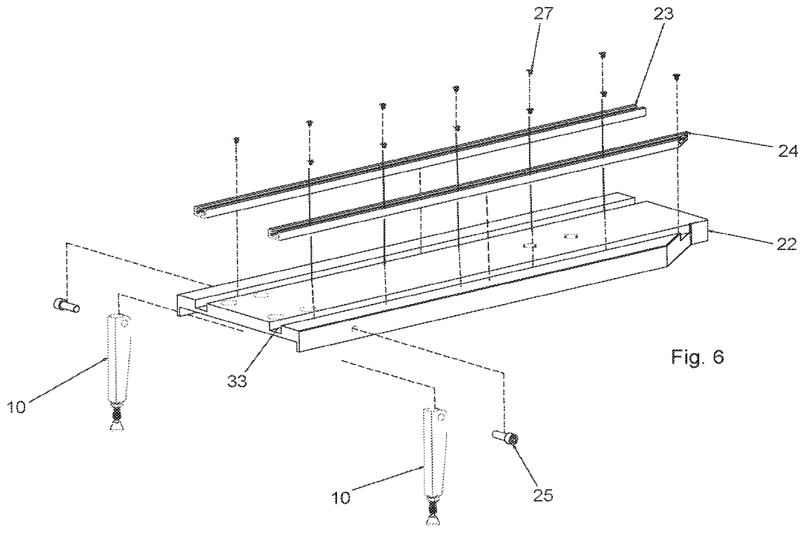

As shown in FIG. 6, such a material support platform may have, and in a method may provide, at least one (in FIG. 6 shown as two) gaps or channels (33). Such channels (33) may run the full length of the material support platform extension arms and may allow for the installation and use of a variety of different types of tracks such as T-Track, Miter Track or other that will allow for the use of accessories, such as clamps, stop blocks, or the like. One or more T-track sections (23) may be configured for placement into a channel (33) and so a method step can involve placing a T-track section (23) in a channel (33). To allow not only different types of T-track sections (which may or may not be truly a T) the T-track section (23) can be a changeable T-track section configured for removable placement into the channel (33).

Further, embodiments may include mounting holes (such as) for a vertical back fence that can move front to back and side to side as needed to support material and allow for zero clearance cuts. Embodiments may include a material support platform (7) mounted to the base (2), such as for the power tool (1) which can allow for unique mobility, as well as allowing it to be used on any surface. As mentioned, other tools, stands, and even more generally accessories, can also be included, thus embodiments can have or be a universal power tool accessory mount (2) or can present a method of universally providing a power tool accessory that can be used even beyond the depicted universal power tool extension support system (31) or method of universally providing an extension support for a power tool.

As shown, embodiments may include a material support platform (7) and extensions (4, 5, 6) for a portable miter saw or like tool that may be highly portable, and lightweight. This can include, for example, a first wing extension (4), and second wing extension (5), and a third wing extension (6). As can be appreciated, these can be interchangeable, and so the extension support, the accessory, or the attachable-detachable material support wings (4, 5, 6) can present at least some interchangeable base attachable-detachable material support wings or the steps of utilizing an interchangeable accessory or support, or utilizing interchangeable base attachable-detachable material support wings, or utilizing interchangeable attachable-detachable material support wings such as shown (especially as 5 and 6).

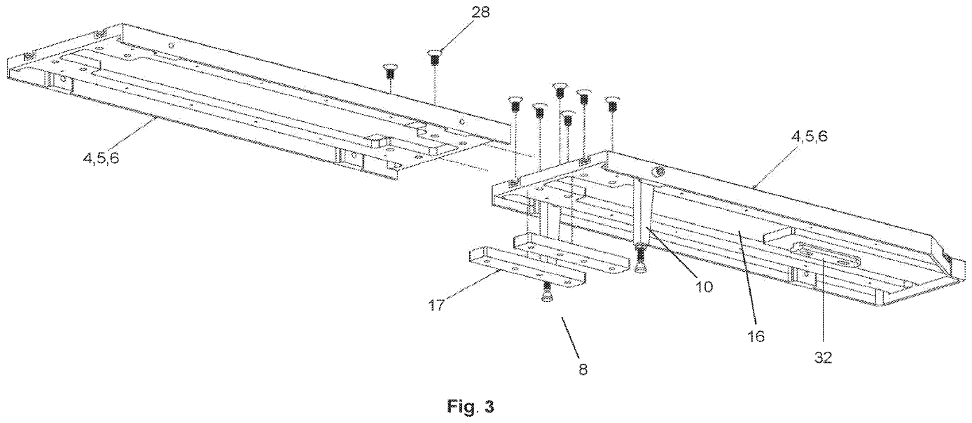

The material support wings (4, 5, 6) may comprise the material support platform (7) and be approximately two feet in length for the main left and right wing (individually) and each additional extension wing may be approximately two feet in length to allow interchangeability and hand carrying of a set of wings (4, 5, 6) and they may be interchangeable from the left to right and vice versa to allow a user to have the material support platform (7) at whatever length or multiple of length desired, which may allow for improved material stabilization during cuts, cleaner cuts, and safer operation of the saw (1) with reduced risk of injury. As shown in FIG. 3, extension pieces/wings (4, 5, 6) may be connected via splicers (8) that may be easily mounted underneath the extension wings (4, 5, 6) via countersunk screws from the top of the wings and may facilitate quick and easy addition or removal of extension wing pieces (5, 6).

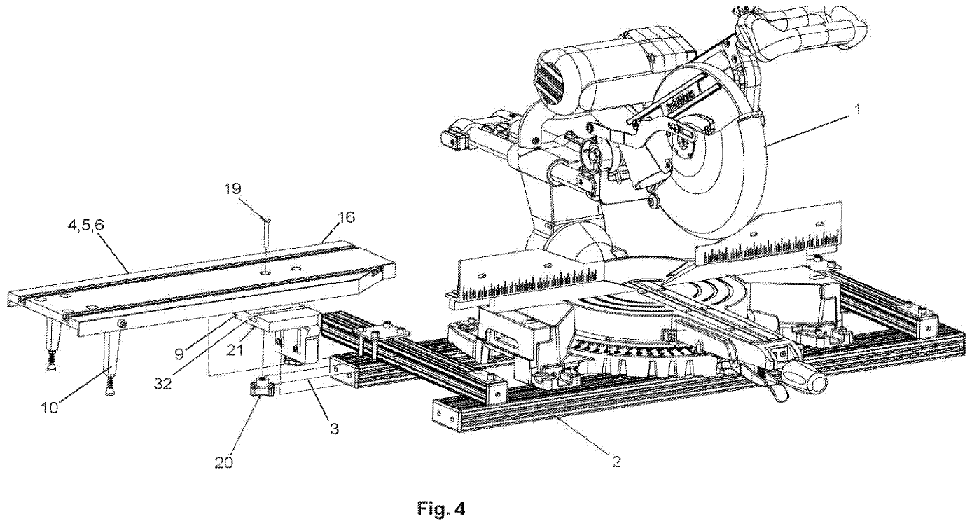

Referring to FIG. 4, embodiments may include a unique design which may allow a user to set up a base such as the power tool securably-pairable, extension support system separably itinerant, substantially universal, substantially permanent, specific power tool pedestal configuration set, base assembly apart from the overall support system. As shown the base can be loosely fitting; it can also be tightly fitting so that every dimension is minimized to the extent practical. When configured more tightly or even more tightly in one precise embodiment where the base has edge adjacent adjustability and is configured to have some components (perhaps such as the side rails (13)) to be power tool edge adjacent, the base can be considered as one type of compact base. Thus, steps can include establishing edge adjacent adjustability for a variety of power tools and the base can be a power tool securably-pairable, compact, extension support system separably itinerant, substantially universal base assembly (2) and the steps can include the step of securing a power tool to a compact, extension support system separably itinerant, substantially universal base assembly.

Whether configured compactly or not, the base (2) can include an attachment assembly (3), or more generally element, perhaps such as the L-Brackets (21) that can even be configured one time to ensure proper placement of the extension wings (4, 5, 6) and be done with them. Thus, the attachment of one or two of the extension supports (4) may be by an extension support at least partially aligning attachment element (such as but not limited to 21 as shown) and whether separately or as an integrated element this may include an adjustable presettable support height adjustment element (such as but not limited to 21 as shown) attached to the base (2) such as the power tool securably-pairable, extension support system separably itinerant, substantially universal base assembly. This can include the step of attaching at least one adjustable presettable support height adjustment element to the power tool securably-pairable, compact, extension support system separably itinerant, substantially universal base assembly. Once in place, the wings (especially 4 but even possibly also 5 and 6) may easily slide on and off for ease of use and assembly/disassembly, perhaps by the step of establishing a T-slide attachment element (32) such as utilizing the T-Slide (9) function of the L-Brackets (21) to allow for perfect alignment and placement of at least some of the wings every time with no need to re-adjust once established as the base (2) and L-Brackets (21) may be left on the saw-base pair once the correct fit is found. Thus, embodiments can have supports or accessories attached by at least one adjustable presettable support height adjustment element and/or at least one extension support at least partially aligning attachment element responsive to at least one adjustable presettable support height adjustment element (32). To achieve the set-once-and-forget aspect at least in the two dimensions as shown, steps can involve presettably at least partially aligning at least one extension support relative to the power tool securably-pairable, compact, extension support system separably itinerant, substantially universal base assembly, adjusting or setting a height relative to the power tool securably-pairable, compact, extension support system separably itinerant, substantially universal base assembly, and even attaching at least one adjustable presettable support height adjustment element to the power tool securably-pairable, compact, extension support system separably itinerant, substantially universal base assembly. As shown, the extensions (4, and indirectly as shown 5, 6) may be held in place on the L-Brackets (21) by the T-Slide (9) and the T-Bolt thumb screw (20) that locks the units in place along the T-Slide (9) on the L-Bracket (21) once the wings (4) are butted up to the miter saw, possibly allowing for the process of mounting and unmounting a wing to take less than approximately 15 seconds, reducing the labor required to transport, set up, and use a miter saw (1). Embodiments may be designed to be used with or without any other structure, i.e.: work benches, miter saw stands, or the like. Embodiments may be made of aluminum allowing for strength and stability during use as well as longevity perhaps due to a protective coating.

As shown in FIG. 6, again it should be understood that embodiments may include two gaps running the full length of the material support platform (7) extension arms (4, 5, 6) that may allow for the installation and use of a variety of different types of tracks (23, 24) such as T-Track, miter track, or other that may allow for the use of accessories, such as clamps and stop blocks. These tracks (23, 24) can also be replaced if they are ever damaged. Embodiments may include holes that allow for the installation of a vertical back fence for material support that can be adjustable both front to back as well as left to right to allow for zero clearance cuts. Other embodiments may include adjustable height legs (10) that may fold up under the extension wings (4, 5, 6) to allow for the smallest possible profile while not in use.

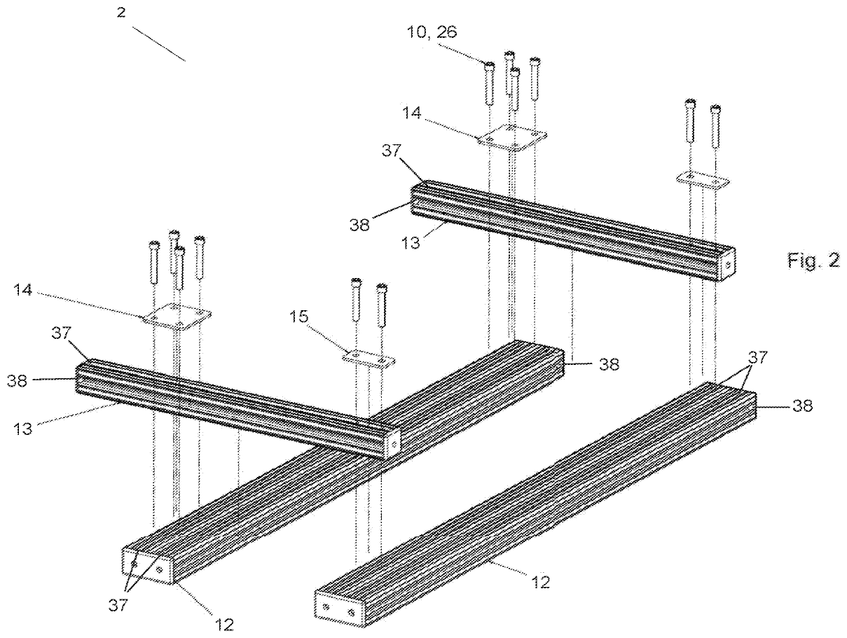

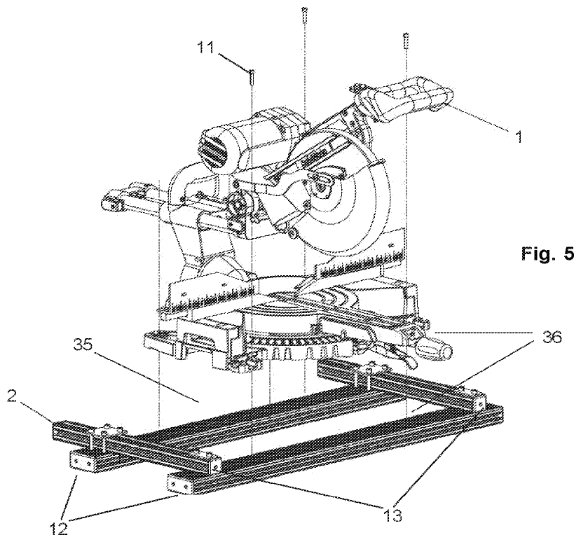

In embodiments such as shown in FIG. 2, there can be a base (2) assembly that may serve as an interface between the user's saw (1) and the EZ-Wing aggregate. The base (2) may include a pair of side base rails (13), or the step of situating a pair of side base rails, and a pair of facing base rails (12), or the step of situating a pair of facing base rails relative to the pair of side base rails. Further, the situation of the individual or the pairs of rails can be highly adjustable. Embodiments can provide or establish a power tool pedestal exterior width distance (e.g., perhaps also the distance between the inside of the side rail pair) adjustment system or achieve the step of establishing a width distance adjustable element or even width distance adjusting a base or the rails in a base. This can include establishing a rail width adjustable side rail pair connection system and connecting by a rail width adjustable element or rail width adjusting the base or the like. This can be done by at least one facing rail integral t-slot or the step of utilizing a facing rail element to position the side rail as desired. And as can be appreciated from FIGS. 2 and 5, for height variability even the rails can be made to be interchangeable, in one instance such as where the facing rails (12), shown as situated below the side rails (13), can be swapped to the top of the side rails and thus designs can provide top-bottom interchangeable rail pairs and the step of utilizing interchangeable rails or rail pairs.

In the depicted base embodiment, the entire assembly may comprise:
5/16″×2″ socket head cap screws (10, 26) (for example, qty 12).
Extruded rails, such as either pair or just the facing base rails (12) perhaps such as 8040×36″ Aluminum Extrusion sections (12) (for example, qty 2). As can be understood from this type of component, the facing rails can present a rail with an integral t-slot, an extruded rail having at least one top t-slot, or the step of providing an extruded rail having a top t-slot, an extruded rail having at least one side t-slot, or the step of providing an extruded rail having a side t-slot, and even rail(s) having symmetric side t-slots and having symmetric top and bottom t-slots, or the steps of providing such items.
Extruded rails, such as either pair or just the side rails (13) perhaps such as 4040×18″ Aluminum Extrusion sections (13) (for example, qty 2). Similarly, as can also be understood from this type of component, the side rails can present rails and steps as explained above.

From the configuration shown, including in FIGS. 4 and 5, it may be appreciated that embodiments can present a universal power tool accessory mount that establishes a substantially universal power tool connection space (35), perhaps established by at least one of the pairs of rails and that possibly even contains at least one integral, continuously repositionable, power tool connection element. And in the method, this particular embodiment can include the step of connecting both pairs of the base rails to create a substantially universal power tool connection space established by at least one of the pairs of rails, perhaps even orthogonal rails. And in these types of spaces, there can be a at least one integral, continuously repositionable, power tool connection system (36) perhaps configured integral to at least one rail of at least one of the pair of rails. As shown in this embodiment, this can include a continuously repositionable rail connection system which is one way to achieve the step of continuously repositionably connecting to a rail. Embodiments can even include a continuously, two-dimensionally adjustable, power tool pedestal attachment point connection space and the step of establishing such a space in that it can be adjustable, for example, in the power tool's left-right and fore-aft positioning relative to either the base or the extension support position. As can be appreciated, embodiments can have a power tool connection-independent and accessory mount-independent rail connection system or can involve the step of connecting a power tool independently of an accessory or support (or vice versa). And there can be at least one support-independent, self-contained power tool connector configured to substantially universally connect a power tool to a continuously adjustable integral connection system or the step of continuously repositionably connecting a power tool integrally, such as to at least one of the rails, at the substantially universal power tool connection space. Further, embodiments can even have these isolated (functionally and/or physically) from each other such that there can be at least one power tool connection isolated accessory mount and this may be connected to at least one of the rails or the step of power tool connection-independently establishing at least one accessory mount connected, perhaps to at least one of the rails, isolated from at least one power tool connection.

As mentioned, the rails can have integral features that can facilitate connection as well as continuously adjustable connections. In understanding the rail embodiment explained above, there can be top t-slots (37) and side t-slots (38) (perhaps for some rail designs this can just be an aspect of the rail's orientation relative to the power tool, as shown) and so embodiments can have at least one facing rail integral top t-slot (37) or the step of establishing at least one facing rail integral top t-slot.

To connect the rails, as shown in FIG. 2 embodiments can include as but one design:
Double Saddle Plates (14) (for example, qty 2)
Bolt Plates (15) (for example, qty 2)
T-Slotted Framing Nuts (for example, qty 12, [internal shown on this drawing]) In exemplary embodiments according to FIGS. 1 and 2, assembly may be achieved by:
Situating the 8040 aluminum extrusion (12) sections parallel to one another and perpendicular to the user's saw (1) blade, spaced at a distance generally equal to the mounting bolt holes of the user's saw (1).
Transversely laying the two 4040 Aluminum extrusion 4040) (13) sections across the 8040 sections (12), such that the supplied mounting holes are nearest to the user, and lay atop the channels in the 8040 below.
Spacing the 4040 sections (13) at a distance that allows the user's saw (1) to be situated between.
Positioning the Bolt Plates (15) over the supplied holes in the 4040 sections (13) and inserting 5/16″ bolts (10, 26) through, into the t-slotted framing nuts in the channels beneath. Bolts may be left finger tight.
Positioning the double saddle plates (14) over the 4040 sections (13), aligned with the 8040 sections (12) below.
Installing 5/16″ bolts (10, 26) through the double saddle plates, straddling the 4040 sections (13) and into the t-slotted framing nuts below. Bolts may be left finger tight.

And as to connecting the rails, or perhaps establishing a connection space, there can be established a continuous fore-aft position adjustable facing rail pair connection system and the step of continuously fore-aft positioning the rails to set a space as desired.

Other embodiments according to the exemplary FIG. 1 may include modular and adjustable characteristics of the extruded segments to allow for installation to any brand, make and model of saw. As can be appreciated, the integral, continuously repositionable, power tool connection system (36) can utilize or include a T-bolt or the step of providing a T-bolt, and perhaps a T-slide attachment element or the step of establishing a T-slide attachment element or more generally a slide-type connection system or establishing a slide-type connection system. These features can be one way of establishing a quick attach-detach connection system so that the accessory or support(s) can be taken off and put on with less steps and even without full alignment activities. Further, such a quick attach-detach connection system can be configured so that there is a quick attach-detach, at least partially preset material support wing attachment element or to involve the step of establishing such an element, or so that there is a quick attach-detach, at least partially relative position-maintainable alignment slide-type connection system or to involve the step of establishing such an element in that at least one position or dimension is maintained or even preset.

As should be understood from the embodiments shown, the base (2) can be highly adjustable especially to be substantially universal so that it can be used with a significant number of power tools if not most popular ones. In fact, dissociating the base configuration from the support configuration in transport is a significant aspect in that the base can be configured to pair with the power tool (perhaps just once as explained above) and separately the support attachment(s) can be configured to pair with the actual support(s) independently of the power tool pairing.

As can be understood, most such fixed (as opposed to hand held) power tools have some sort of pedestal or foundation which allows them to be mounted at a desired location (even if that mounting is not always accomplished), such as when these types of power tools are used at varying job sites or locations. Different power tools can have different pedestals and in these different pedestals there can be different attachment point locations and different attachment points-usually holes through which bolts or such can be placed to mount the power tool. As some of the ways in which embodiments can achieve the desired universal-ness, embodiments can provide a power tool pedestal attachment point front-back distance adjustable connection space and even accomplish the step of adjustably connecting the power tool to the base, a power tool pedestal attachment point left side location adjustable connection space, and the step of left side adjustably connecting the two, a power tool pedestal attachment point right side location adjustable connection space, and the step of right side adjustably connecting the two, or the like. The base can also allow the power tool to fit on/in the base providing an adjustable power tool pedestal nestled between rails space or accomplishing the step of nestling the power tool in or on the base space. And embodiments can even establish a power tool on a base or a connection space that is configured for edge adjacent adjustability for a variety of power tools.

Additional aspects to the degree of adjustability provided can be understood as providing a power tool pedestal attachment point depth adjustment system or even perhaps the step of depth adjusting power tool pedestal attachment point(s). There can also be an integral continuously repositionable power tool pedestal attachment point connection system or also the step of connecting the power tool in a manner that is integral (perhaps a part of) some component, and continuously repositionable in that even small shifts (perhaps to the degree of precisely properly aligning with holes of the like) or the step of connecting the power tool integrally and continuously repositionably to the base or other component. And for embodiments such as depicted, this last aspect can be achieved by including a continuously repositionable depth adjustable facing rail pair connection system or even the step of connecting in a manner that is or by a continuously repositionably depth adjustable element.

In embodiments according to exemplary FIGS. 3 and 6, the wing assembly may serve as a foundational support mechanism. It may comprise the following parts:
Base Wing (16) (for example, qty 1)
Adjustable height support legs (10) (for example, qty 2)
24″ T-track section (23), stock.
24″ T-track section (24), modified
5/16″× 15/16″ socket head cap screws (27) (for example, qty 2)
6-32× 3/16″ flat head screws (28) (for example, qty 12)·
Splice plate (17)

Assembly may be achieved by:
Aligning the t-track sections (23, 24) with their respective channels in the base wing component (16).
Securing the t-track sections (23, 24) into the channels using the 6-32 flat head fasteners (28).
Fastening the support legs (10) to the base wing component (16) using the 5/16″ socket head fasteners.

In embodiments according to exemplary FIGS. 3 and 6, unique features and capabilities may include:
T-track (23, 24) components allow for the use of a multitude of commercially available accessories such as hold-down clamps, alignment jigs, measuring devices and stop blocks.
Adjustable support legs (10) allow for use on surfaces of varying planar elevations relative to the saw.

In embodiments according to exemplary FIG. 4, a full assembly outlines the EZ-wings assembly (left side shown herein and on FIG. 3), installed to a user's saw (1), and may comprise the following:
Saw (1) with base assembly (2)
wing assembly (4, 5, 6)
Locking t-bolt (19)
Wing lock knob (20)
Adjustable bracket assembly (21)

In exemplary embodiments, assembly may be achieved by:
Installing the adjustable bracket assembly (21) into the outer face of the transverse 4040 section, using the 5/16″ fasteners, threaded into t-slotted framing nuts in the 4040 section. Fasteners may be left finger tight.
Sliding the wing assembly (16) onto the dovetail feature of the Adjustable Bracket Assembly until contact with the user's existing saw platform is made.
Installing the locking t-bolt (19) through the wing assembly platform, into the wing lock knob and tightening by hand.
Turning an adjustable bracket assembly adjustment knob to raise or lower the wing assembly to match the planar elevation of the user's existing saw platform.
Sliding the wing assembly/adjustable bracket assembly fore and aft on the 4040 section until the desired wing alignment is achieved.
Tightening the 5/16″ fasteners on the Adjustable Bracket Assembly into the Base Assembly 4040 section. This will lock the wing height and location in place.

Removal of the wing assembly from the full assembly may be achieved by:
Loosening the wing lock knob (20) to allow partial rotation of the locking t-bolt (19), which will withdraw from underneath the wing assembly.
Sliding the wing assembly (16) to the left end of the adjustable bracket assembly dovetail.

In embodiments according to FIGS. 3 and 4, unique features and capabilities may include:
Adjustment knobs which may allow fine tuning of the Wing Assembly height.
Locking t-bolt (19) is captured in a specifically designed feature of the Wing Assembly platform to allow removal without complete unthreading from the wing lock knob (20).
Quick removal of the wing assembly (16) which may allow easy transport/storage of the saw (1) with base assembly (2) (shown in FIG. 4), without geometry impeding considerably from that of the user's stock saw envelope.
Fasteners can allow the wing assembly height to be repeatably accurate after removal and reinstallation, given the permanence of the adjustable bracket assembly location.

As mentioned above whether provided as part of a universal power tool extension support system or as a universal power tool accessory mount, the base (2) can use an attachment assembly (3) perhaps such as the L-Brackets (21) that may be set one time to ensure proper placement of the extension wings (4, 5, 6) and be done with them. This can involve setting height as described above. It can also involve depth and width adjustments. Embodiments can provide a power tool relative-to-extension support at least partially aligning attachment element continuous fore-aft position adjustment system and the step of at least partially aligning an accessory or support attachment element. As but one example, this can be accomplished by sliding the accessory or support onto an element such as, in one embodiment, is already adjusted to make sure the support or accessory is at the correct height as mentioned but perhaps also at the correct fore-aft position relative to where the power tool is or will be already attached. The step of fore-aft positioning can be done such as by sliding or positioning the attachment element connection using the t-slots in the base rails or the like. Embodiments can provide or establish at least one extruded rail having at least one side rail integral outside t-slot, and the height adjustment element can be attached to at least one rail integral outside t-slot. Further, there can be provided an aligning attachment element that is integral to an adjustable presettable support height adjustment element. Embodiments can provide an at least part preset alignment connection system or the step of presetting at least part of an accessory or support alignment. As explained, in general there can be at least one accessory attachment element and the step of attaching an accessory or support, an accessory at least partially aligning attachment element and the step of at least partially aligning an accessory, or even at least one workpiece support at least partially aligning attachment element and the step of at least partially aligning a workpiece support.

In embodiments according to FIG. 5, a user's saw (1) may be affixed to a base (2) assembly by the following method:
Situate the saw atop the two 8040 sections (12) of the base assembly, generally centered between the two transverse 4040 sections (13).
Align saw mounting bolt holes with a channel in the 8040 sections (12) (channel selection may be unimportant, and can be selected at the user's discretion, provided that the 8040 sections (12) maintain parallelism to each other and perhaps the back fence of the user's saw).
Install 5/16″ socket head cap screws (11) through the saw mounting holes, into t-slotted framing nuts in the 8040 channels underneath. Screws may be left finger tight.
Slide the two transverse 4040 sections (13) together until they nearly contact the user's saw (1).
Ensure the 4040 sections (13) are precisely perpendicular to the back fence of the user's saw (1) (and generally to the 8040 sections (12)) and tighten the (12) 5/16″ bolts of the base assembly (2).
Tighten the 5/16″ fasteners (11) in the saw mounting holes.

In embodiments according to FIG. 5, unique features and capabilities may include having a base assembly (2) as a nearly permanent fixture on the user's saw (1). By providing a base assembly that is designed to be attached to the power tool and then left on for multiple attachments and detachments of an accessory or support, embodiments can present a substantially permanent, specific power tool pedestal configuration set, base assembly and the step of substantially permanently connecting a base to a power tool for use of the system.

In embodiments according to FIG. 6, a wing assembly may serve as the foundational support mechanism for the apparatus. It may comprise the following parts:
base wing (22) (for example, qty 1)
adjustable height support legs (10) (for example, qty 2)
a T-track section (23) at an exemplary length of 24″,
a modified T-track section (24) at an exemplary length of 24″
5/16″× 15/16″ socket head cap screws (25) (for example, qty 2)
6-32× 3/16″ flat head screws (27) (for example, qty 12)

In such embodiments, assembly may be achieved by:
Aligning the t-track sections (23, 24) with their respective channels in the base wing component.
Securing the t-track sections (23) into the channels using the 6-32 flat head (27) fasteners.
Fastening the support legs (10) to the base wing component using the 5/16″ socket head (25) fasteners.

In embodiments according to FIG. 6, unique features and capabilities might include T-track (23, 24) components that allow for the use of a multitude of commercially available accessories such as hold-down clamps, alignment jigs, measuring devices and stop blocks. Embodiments may also include adjustable support legs (10) allow for use on surfaces of varying planar elevations relative to the saw.

While the invention has been described in connection with some preferred embodiments, it is not intended to limit the scope of the invention to the particular form set forth, but on the contrary, it is intended to cover such alternatives, modifications, and equivalents as may be included within the spirit and scope of the invention as defined by the statements of inventions. Examples of alternative claims may include the following clauses:

1. A universal power tool extension support system comprising:
a power tool securably-pairable, extension support system separably itinerant, substantially universal, substantially permanent, specific power tool pedestal configuration set, base assembly;
at least one integral, continuously repositionable, power tool connection system configured integral to said power tool securably-pairable, extension support system separably itinerant, substantially universal, substantially permanent, specific power tool pedestal configuration set, base assembly;
at least one adjustable presettable support height adjustment element attached to said power tool securably-pairable, compact, extension support system separably itinerant, substantially universal base assembly;
at least one extension support at least partially aligning, and power tool connection isolated, attachment element responsive to said at least one adjustable presettable support height adjustment element;
at least one independent, individually base attachable-detachable, extension support configured to be detachably attached to said power tool securably-pairable, compact, extension support system separably itinerant, substantially universal base assembly by said at least one extension support at least partially aligning attachment element.

2. A universal power tool extension support system as described in clause 1 or any other clause wherein said power tool securably-pairable, extension support system separably itinerant, substantially universal base assembly comprises: a pair of side base rails; and a pair of facing base rails.

3. A universal power tool extension support system as described in clause 1 or any other clause and further comprising at least one support-independent, self-contained power tool connector.

4. A universal power tool extension support system as described in clause 2 or any other clause wherein said at least one of said rails comprises at least one extruded rail having at least one top t-slot.

5. A universal power tool extension support system as described in clause 2 or any other clause wherein said at least one of said rails comprises at least one extruded rail having at least one side t-slot.

6. A universal power tool extension support system as described in clause 2 or any other clause wherein said each of said rail pairs comprises a pair of extruded rails, each having symmetric side t-slots and having symmetric top and bottom t-slots.

7. A universal power tool extension support system as described in clause 2 or any other clause wherein said each of said rail pairs comprises top-bottom interchangeable rail pairs.

8. A universal power tool extension support system as described in clause 2 or any other clause wherein said at least one extension support at least partially aligning, and power tool connection isolated, attachment element comprises a quick attach-detach connection system.

9. A universal power tool extension support system as described in clause 8 or any other clause wherein said quick attach-detach connection system comprises a T-bolt.

10. A universal power tool extension support system as described in clause 1 or any other clause wherein said at least one extension support at least partially aligning, and power tool connection isolated, attachment element is integral to said at least one adjustable presettable support height adjustment element.

11. A universal power tool extension support system as described in clause 2 or any other clause and further comprising a power tool relative-to-said at least one extension support at least partially aligning, and power tool connection isolated, attachment element continuous fore-aft position adjustment system.

12. A universal power tool extension support system as described in clause 1 or any other clause and further comprising a power tool pedestal attachment point depth adjustment system.

13. A universal power tool extension support system as described in clause 12 or any other clause wherein said at least one integral continuously repositionable power tool connection system comprises a continuously repositionable depth adjustable facing rail pair connection system.

14. A universal power tool extension support system as described in clause 1 or any other clause and further comprising a power tool pedestal exterior width distance adjustment system.

15. A universal power tool extension support system as described in clause 14 or any other clause wherein said power tool pedestal exterior width distance adjustment system comprises a rail width adjustable side rail pair connection system.

16. A universal power tool accessory mount as described in clause 1 or any other clause and further comprising a power tool connection-independent and accessory mount-independent rail connection system that connects said at least one pair of side rails to said at least one pair of facing rails.

17. A universal power tool accessory mount as described in clause 1 or any other clause and further comprising: a power tool pedestal attachment point front-back distance adjustable connection space; a power tool pedestal attachment point left side location adjustable connection space; and a power tool pedestal attachment point right side location adjustable connection space.

18. A universal power tool accessory mount as described in clause 1 or any other clause and further comprising a substantially universal adjustable power tool pedestal nestled between rails space.

19. A universal power tool extension support system comprising:
a power tool securably-pairable, compact, extension support system separably itinerant, substantially universal base assembly;
at least one adjustable presettable support height adjustment element attached to said power tool securably-pairable, compact, extension support system separably itinerant, substantially universal base assembly;
at least one extension support at least partially aligning attachment element responsive to said at least one adjustable presettable support height adjustment element;
at least one independent, individually base attachable-detachable, extension support configured to be detachably attached to said power tool securably-pairable, compact, extension support system separably itinerant, substantially universal base assembly by said at least one extension support at least partially aligning attachment element.

20. A universal power tool extension support system as described in clause 19 or any other clause wherein said power tool securably-pairable, compact, extension support system separably itinerant, substantially universal base assembly comprises a substantially permanent, specific power tool pedestal configuration set, base assembly.

21. A universal power tool extension support system as described in clause 19 or any other clause wherein said power tool securably-pairable, compact, extension support system separably itinerant, substantially universal base assembly comprises: a pair of side base rails; and a pair of facing base rails.

22 A universal power tool extension support system as described in clause 21 or any other clause wherein said power tool securably-pairable, compact, extension support system separably itinerant, substantially universal base assembly further comprises at least one integral, continuously repositionable, power tool connection system.

23. A universal power tool extension support system as described in clause 22 or any other clause and further comprising at least one support-independent, self-contained power tool connector.

24. A universal power tool extension support system as described in clause 23 or any other clause wherein said at least one extension support at least partially aligning attachment element comprises at least one power tool connection isolated accessory mount connected to at least one of said rails.

25 A universal power tool extension support system as described in clause 21 or any other clause wherein said at least one of said rails comprises at least one extruded rail having at least one top t-slot.

26 A universal power tool extension support system as described in clause 21 or any other clause wherein said at least one of said rails comprises at least one extruded rail having at least one side t-slot.

27. A universal power tool extension support system as described in clause 25 or any other clause wherein said at least one of said rails comprises at least one extruded rail having at least one side t-slot.

28. A universal power tool extension support system as described in clause 27 or any other clause wherein said each of said rail pairs comprises at least one extruded rail having at least one side t-slot and having at least one top t-slot.

29. A universal power tool extension support system as described in clause 27 or any other clause wherein said each of said rail pairs comprises a pair of extruded rails, each having symmetric side t-slots and having symmetric top and bottom t-slots.

30. A universal power tool extension support system as described in clause 22 or any other clause wherein said at least one integral, continuously repositionable, power tool connection system comprises at least one rail integral t-slot.

31. A universal power tool extension support system as described in clause 21 or any other clause wherein said each of said rail pairs comprises top-bottom interchangeable rail pairs.

32. A universal power tool extension support system as described in clause 19 or any other clause wherein said at least one independent, individually base attachable-detachable, extension support comprises at least one base attachable-detachable material support wing.

33. A universal power tool extension support system as described in clause 32 or any other clause wherein said at least one base attachable-detachable material support wing comprises at least one interchangeable base attachable-detachable material support wing.

34. A universal power tool extension support system as described in clause 33 or any other clause wherein said at least one interchangeable base attachable-detachable material support wing comprises a T-slide attachment element.

35. A universal power tool extension support system as described in clause 33 or any other clause wherein said at least one interchangeable base attachable-detachable material support wing comprises at least one channel, and further comprising at least one T-track section configured for placement into said channel.

36 A universal power tool extension support system as described in clause 35 or any other clause wherein said at least one T-track section configured for placement into said channel comprises at least one changeable T-track section configured for removable placement into said channel.

37. A universal power tool extension support system as described in clause 21 or any other clause wherein said at least one extension support at least partially aligning attachment element comprises a quick attach-detach connection system.

38. A universal power tool extension support system as described in clause 37 or any other clause wherein said quick attach-detach connection system comprises a T-bolt.

39. A universal power tool extension support system as described in clause 38 or any other clause wherein said quick attach-detach connection system further comprises a T-slide attachment element.

40. A universal power tool extension support system as described in clause 21 or any other clause wherein said at least one extension support at least partially aligning attachment element comprises a slide-type connection system.

41. A universal power tool extension support system as described in clause 40 or any other clause wherein said slide-type connection system comprises a T-bolt.

42. A universal power tool extension support system as described in clause 19 or any other clause wherein said at least one extension support at least partially aligning attachment element comprises a quick attach-detach, at least partially preset material support wing attachment element.

43. A universal power tool extension support system as described in clause 42 or any other clause wherein said quick attach-detach, at least partially preset material support wing attachment element comprises a quick attach-detach, at least partially relative position-maintainable alignment slide-type connection system.

44. A universal power tool extension support system as described in clause 21 or any other clause wherein said at least one of said side rails comprises at least one extruded rail having at least one side rail integral outside t-slot, and wherein said at least one adjustable presettable support height adjustment element is attached to said at least one rail integral outside t-slot.

45. A universal power tool extension support system as described in clause 19 or any other clause wherein said at least one extension support at least partially aligning attachment element is integral to said at least one adjustable presettable support height adjustment element.

46. A universal power tool extension support system as described in clause 21 or any other clause and further comprising a power tool relative-to-said at least one extension support at least partially aligning attachment element continuous fore-aft position adjustment system.

47. A universal power tool extension support system as described in clause 21 or any other clause wherein said power tool relative-to-said at least one extension support at least partially aligning attachment element continuous fore-aft position adjustment system at least partially comprises a continuous fore-aft position adjustable facing rail pair connection system.

48. A universal power tool extension support system as described in clause 47 or any other clause wherein said continuous fore-aft position adjustable facing rail pair connection system comprises at least one rail integral t-slot.

49. A universal power tool extension support system as described in clause 47 or any other clause wherein said power tool relative-to-said at least one extension support at least partially aligning attachment element continuous fore-aft position adjustment system further comprises at least one side rail integral outside t-slot.

50. A universal power tool extension support system as described in clause 19 or any other clause and further comprising a power tool pedestal attachment point depth adjustment system.

51. A universal power tool extension support system as described in clause 50 or any other clause wherein said power tool pedestal attachment point depth adjustment system comprises an integral continuously repositionable power tool pedestal attachment point connection system.

52. A universal power tool extension support system as described in clause 51 or any other clause wherein said integral continuously repositionable power tool pedestal attachment point connection system comprises a continuously repositionable depth adjustable facing rail pair connection system.

53. A universal power tool extension support system as described in clause 51 or any other clause wherein said continuously repositionable depth adjustable facing rail pair connection system comprises at least one rail integral t-slot.

54 A universal power tool extension support system as described in clause 51 or any other clause wherein said continuously repositionable depth adjustable facing rail pair connection system comprises at least one side rail integral top t-slot.

55. A universal power tool extension support system as described in clause 19 or any other clause and further comprising a power tool pedestal exterior width distance adjustment system.

56. A universal power tool extension support system as described in clause 55 or any other clause wherein said power tool pedestal exterior width distance adjustment system comprises a rail width adjustable side rail pair connection system.

57. A universal power tool extension support system as described in clause 56 or any other clause wherein said rail width adjustable side rail pair connection system comprises at least one facing rail integral t-slot.

58. A method of universally providing an extension support for a power tool comprising the steps of:

securing a power tool to a compact, extension support system separably itinerant, substantially universal base assembly;
attaching at least one adjustable presettable support height adjustment element to said power tool securably-pairable, compact, extension support system separably itinerant, substantially universal base assembly;
presettably at least partially aligning at least one extension support relative to said power tool securably-pairable, compact, extension support system separably itinerant, substantially universal base assembly; and
detachably attaching at least one independent, individually base attachable-detachable, extension support to said power tool securably-pairable, compact, extension support system separably itinerant, substantially universal base assembly by said at least one adjustable presettable support height adjustment element.

59. A universal power tool accessory mount comprising:
a pair of side base rails;
a pair of facing base rails;
at least one integral, continuously repositionable, power tool connection system configured integral to at least one rail of at least one of said pair of rails;
a substantially universal power tool connection space established by at least one of said pairs of rails and that contains said at least one integral, continuously repositionable, power tool connection system;
at least one support-independent, self-contained power tool connector configured to substantially universally connect a power tool to said at least one integral, continuously repositionable, power tool connection system;
at least one power tool connection isolated accessory mount connected to at least one of said rails.

60. A universal power tool accessory mount as described in clause 59 or any other clause wherein said pair of side base rails and said pair of facing base rails comprises substantially orthogonal rail pairs.

61. A universal power tool accessory mount as described in clause 59 or any other clause wherein said at least one of said rails comprises at least one extruded rail having at least one top t-slot.

62. A universal power tool accessory mount as described in clause 59 or any other clause wherein said at least one of said rails comprises at least one extruded rail having at least one side t-slot.

63. A universal power tool accessory mount as described in clause 61 or any other clause wherein said at least one of said rails comprises at least one extruded rail having at least one side t-slot.

64 A universal power tool accessory mount as described in clause 63 or any other clause wherein said each of said rail pairs comprises at least one extruded rail having at least one side t-slot and having at least one top t-slot.

65. A universal power tool accessory mount as described in clause 63 or any other clause wherein said each of said rail pairs comprises a pair of extruded rails, each having symmetric side t-slots and having symmetric top and bottom t-slots.

66. A universal power tool accessory mount as described in clause 59 or any other clause wherein said at least one integral, continuously repositionable, power tool connection system comprises at least one rail integral t-slot.

67. A universal power tool accessory mount as described in clause 59 or any other clause wherein said at least one integral, continuously repositionable, power tool connection system comprises at least one facing rail integral top t-slot.

68. A universal power tool accessory mount as described in clause 59 or any other clause and further comprising a power tool connection-independent and accessory mount-independent rail connection system that connects said at least one pair of side rails to said at least one pair of facing rails.

69. A universal power tool accessory mount as described in clause 68 or any other clause wherein said power tool connection-independent and accessory mount-independent rail connection system comprises a continuously repositionable rail connection system.

70. A universal power tool accessory mount as described in clause 59 or any other clause wherein said each of said rail pairs comprises top-bottom interchangeable rail pairs.

71 A universal power tool accessory mount as described in clause 59 or any other clause wherein said substantially universal power tool connection space comprises a continuously, two-dimensionally adjustable, power tool pedestal attachment point connection space.

72. A universal power tool accessory mount as described in clause 71 or any other clause wherein said continuously, two-dimensionally adjustable, power tool pedestal attachment point connection space comprises: a power tool pedestal attachment point front-back distance adjustable connection space; a power tool pedestal attachment point left side location adjustable connection space; and a power tool pedestal attachment point right side location adjustable connection space.

73 A universal power tool accessory mount as described in clause 59 or any other clause wherein said substantially universal power tool connection space comprises an adjustable power tool pedestal nestled between rails space.

74. A universal power tool accessory mount as described in clause 73 or any other clause wherein said adjustable power tool pedestal nestled between rails space is configured for edge adjacent adjustability for a variety of power tools.

75. A universal power tool accessory mount as described in clause 59 or any other clause wherein said at least one power tool connection isolated accessory mount comprises a quick attach-detach connection system.

76. A universal power tool accessory mount as described in clause 75 or any other clause wherein said quick attach-detach connection system comprises a T-bolt.

77 A universal power tool accessory mount as described in clause 76 or any other clause wherein said quick attach-detach connection system further comprises a T-slide attachment element.

78. A universal power tool accessory mount as described in clause 75 or any other clause wherein said quick attach-detach connection system comprises an at least part preset alignment connection system.

79. A universal power tool accessory mount as described in clause 78 or any other clause wherein said at least part preset alignment connection system comprises a slide-type connection system.

80 A universal power tool accessory mount as described in clause 79 or any other clause wherein said slide-type connection system comprises T-bolt.

81. A universal power tool accessory mount as described in clause 59 or any other clause wherein said at least one power tool connection isolated accessory mount comprises a quick attach-detach, at least partially preset material support wing attachment element.

82 A universal power tool accessory mount as described in clause 81 or any other clause wherein said quick attach-detach, at least partially preset material support wing attachment element comprises a quick attach-detach, at least partially relative position-maintainable alignment slide-type connection system.

83. A universal power tool accessory mount as described in clause 59 or any other clause and further comprising at least one adjustable presettable support height adjustment element.

84. A universal power tool accessory mount as described in clause 83 or any other clause wherein said at least one of said side rails comprises at least one extruded rail having at least one side rail integral outside t-slot, and wherein said at least one adjustable presettable support height adjustment element is attached to said at least one rail integral outside t-slot.

85 A universal power tool accessory mount as described in clause 59 or any other clause and further comprising at least one accessory attachment element.

86. A universal power tool accessory mount as described in clause 85 or any other clause wherein said at least one accessory attachment element comprises at least one accessory at least partially aligning attachment element.

87 A universal power tool accessory mount as described in clause 86 or any other clause wherein said at least one accessory at least partially aligning attachment element comprises at least one workpiece support at least partially aligning attachment element.

88. A universal power tool accessory mount as described in clause 83 or any other clause wherein said at least one power tool connection isolated accessory mount is integral to said at least one adjustable presettable support height adjustment element.

89. A universal power tool accessory mount as described in clause 59 or any other clause and further comprising a power tool relative-to-said at least one extension support at least partially aligning attachment element continuous fore-aft position adjustment system.

90. A universal power tool accessory mount as described in clause 69 or any other clause wherein said power tool relative-to-said at least one extension support at least partially aligning attachment element continuous fore-aft position adjustment system at least partially comprises a continuous fore-aft position adjustable facing rail pair connection system.

91. A universal power tool accessory mount as described in clause 90 or any other clause wherein said continuous fore-aft position adjustable facing rail pair connection system comprises at least one rail integral t-slot.

92. A universal power tool accessory mount as described in clause 59 or any other clause and further comprising a power tool pedestal attachment point depth adjustment system.

93. A universal power tool accessory mount as described in clause 69 or any other clause wherein said continuously repositionable rail connection system comprises an integral continuously repositionable power tool pedestal attachment point connection system.

94. A universal power tool accessory mount as described in clause 92 or any other clause wherein said power tool pedestal attachment point depth adjustment system comprises at least one rail integral t-slot.

95. A universal power tool accessory mount as described in clause 92 or any other clause wherein said power tool pedestal attachment point depth adjustment system comprises at least one side rail integral top t-slot.

96. A universal power tool accessory mount as described in clause 59 or any other clause and further comprising a power tool pedestal exterior width distance adjustment system.

97. A universal power tool accessory mount as described in clause 69 or any other clause wherein said continuously repositionable rail connection system comprises a rail width adjustable side rail pair connection system.

98. A universal power tool accessory mount as described in clause 97 or any other clause wherein said rail width adjustable side rail pair connection system comprises at least one facing rail integral t-slot.

99. A method of universally providing a power tool accessory mount comprising the steps of:
situating a pair of side base rails;
situating a pair of facing base rails relative to said pair of side base rails;
connecting both pairs of said base rails to create a substantially universal power tool connection space established by at least one of said pairs of rails;
continuously repositionably connecting a power tool integrally to at least one of said rails at said substantially universal power tool connection space;
power tool connection-independently establishing at least one accessory mount connected to at least one of said rails isolated from said at least one power tool connection.

As can be easily understood from the foregoing, the basic concepts of the various embodiments of the present invention(s) may be embodied in a variety of ways. It involves both support techniques as well as devices to accomplish the appropriate tool support. In this application, the support techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the various embodiments of the invention(s) and may not explicitly show how each feature or element can actually be representative of a broader function or of a great variety of alternative or equivalent elements. As one example, terms of degree, terms of approximation, and/or relative terms may be used. These may include terms such as the words: substantially, about, only, and the like. These words and types of words are to be understood in a dictionary sense as terms that encompass an ample or considerable amount, quantity, size, etc. as well as terms that encompass largely but not wholly that which is specified. Further, for this application if or when used, terms of degree, terms of approximation, and/or relative terms should be understood as also encompassing more precise and even quantitative values that include various levels of precision and the possibility of claims that address a number of quantitative options and alternatives. Where the application is described in device-oriented terminology, each element of the device implicitly performs a function. Apparatus claims may not only be included for the device described, but also method or process claims may be included to address the functions of the embodiments and that each element performs. Further as to method or process claims, it should be noted that only initial method claims are presented. Dependencies tracking each of the apparatus dependencies in method parlance and even including process step language from the specification should be understood as encompassed in and disclosed by this application and such claims may be added at a later date if/when desired. Neither the description nor the terminology is intended to limit the scope of the claims that will be included in any subsequent patent application.

It should also be understood that a variety of changes may be made without departing from the essence of the various embodiments of the invention(s). Such changes are also implicitly included in the description. They still fall within the scope of the various embodiments of the invention(s). A broad disclosure encompassing the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of embodiments of the invention(s) both independently and as an overall system.

Further, each of the various elements of the embodiments of the invention(s) and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the various embodiments of the invention(s), the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which embodiments of the invention(s) is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “support” should be understood to encompass disclosure of the act of “supporting”—whether explicitly discussed or not—and, conversely, were there effectively disclosure of the act of “supporting”, such a disclosure should be understood to encompass disclosure of a “support” and even a “means for supporting.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function. As other non-limiting examples, it should be understood that claim elements can also be expressed as any of: components, programming, subroutines, logic, or elements that are configured to, or configured and arranged to, provide or even achieve a particular result, use, purpose, situation, function, or operation, or as components that are capable of achieving a particular activity, result, use, purpose, situation, function, or operation. All should be understood as within the scope of this disclosure and written description.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of the various embodiments of invention(s) such statements are expressly not to be considered as made by the applicant(s).

### Us Patents

| Patent No. | Kind Code | Date Issued | Patentee |
|---|---|---|---|
| 4,075,920 | | Feb. 28, 1978 | Neal |
| 4,111,409 | | Sep. 5, 1978 | Smith |
| 4,341,247 | | Jul. 27, 1982 | Price |
| 4,561,336 | | Dec. 31, 1985 | Davis |
| 4,677,920 | | Jul. 7, 1987 | Eccardt |
| 4,798,113 | | Jan. 17, 1989 | Viazanko |
| 4,817,693 | | Apr. 4, 1989 | Schuler |
| 4,860,807 | | Aug. 29, 1989 | Vacchiano |
| 4,874,025 | | Oct. 17, 1989 | Cleveland |
| 4,919,384 | | Apr. 24, 1990 | Grimberg |
| 5,038,650 | | Aug. 13, 1991 | Hodge |
| 5,105,862 | | Apr. 21, 1992 | Skinner |
| 5,997,229 | | Dec. 7, 1999 | Akers |
| 6,253,898 | B1 | Jul. 3, 2001 | O'Brien |
| 7,610,839 | B1 | Nov. 3, 2009 | Bessette |
| 7,621,206 | B2 | Nov. 24, 2009 | Makropoulos |
| 8,539,689 | B2 | Sep. 24, 2013 | Di Nicolantonio |
| 8,967,607 | B2 | Mar. 3, 2015 | Ducek |
| 11,554,513 | B1 | Jan. 17, 2023 | Larsson |

### Us Publications

| Publication No. | Kind Code | Date Published | Patentee |
|---|---|---|---|
| 20130118332 | A1 | May 16, 2013 | Barnes |
| 20230330889 | A1 | Oct. 19, 2023 | Crabb |
| 2023/0381874 | A1 | Nov. 30, 2023 | KURAJDOVA |

### Foreign Patent Documents

| | Country | Kind | Date | |
|---|---|---|---|---|
| Publication No. | Code | Code | Published | Patentee |
| 1159872 | CA | | Jan. 3, 1984 | Price |
| 9904175 | WO | | Jan. 28, 1999 | Akers |
| 112025331 | CN | A | Dec. 4, 2020 | NINGXIA |
| | | | | AOQUN TECH |
| | | | | CO LTD |
| 213532962 | CN | U | Jun. 5, 2021 | QINGDAO |
| | | | | HOUDA |
| | | | | MACHINERY |
| | | | | MFG CO LTD |
| 102004017420 | DE | A1 | Nov. 3, 2005 | METABOWERKE |
| | | | | GMBH [DE] |
| 2009147152 | WO | A1 | Dec. 10, 2009 | Raff |

### Non Patent Literature

Provisional App
EZ-Wings PRO+ 12′ Portable Miter Saw Station - Red House Tools. Obtained Jan. 10, 2024.
5 pages. https://redhousetools.com/products/ez-wings-pro-plus-miter-saw-support-system-
total-of-12-of-material-support?variant-47245504053533&currency=USD&utm_m . . .
FNICEL Customize Tools Store. 5 pages. Obtained Jan. 10, 2024. www.aliexpress.com
Miter Saw Extension Fence Kit. Obtained Jan. 10, 2024. 3 pages. The Wayback Machine -
https://web.archive.org/web/20170707234708/http://ptreeusa.com/mitersaw_extension_pla
ns.html
Saw Stand Products. Obtained Jan. 12, 2023. 4 pages. website
Saw Stand Products - FastCap. Obtained Mar. 3, 2023. 4 pages.
https://www.fastcap.com/products/best-fence-pro

Thus, the applicant(s) should be understood to have support to claim and make claims to embodiments including at least: i) each of the support devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123 (2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrases “comprising”, “including”, “containing”, “characterized by” and “having” are used to maintain the “open-end” claims herein, according to traditional claim interpretation including that discussed in MPEP § 2111.03. Thus, unless the context requires otherwise, it should be understood that the terms “comprise” or variations such as “comprises” or “comprising”, “include” or variations such as “includes” or “including”, “contain” or variations such as “contains” and “containing”, “characterized by” or variations such as “characterizing by”, “have” or variations such as “has” or “having”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 9 or any other claim” or the like, it could be re-drafted as dependent on claim 1, claim 8, or even claim 11 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

With respect to the drawings, it should be understood that these present only initial views, mirror views such as left, right, top, bottom, front, and back should be understood as within the realm of this disclosure as may be appropriate for design or industrial design protections. Furthermore, any aspect and any portion of such drawings should be understood as potentially not within the scope of any then-made claim such as by then dashing any portion desired or indicating indeterminate length or the like. And such drawings should be understood as including drawing elements such as rectangles, circles, ellipses, ovals, squares, and the like as particular side or other views as well understood from the existing drawings.

Finally, any claims set forth at any time are hereby incorporated by reference as part of this description of the various embodiments of the application, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A universal power tool extension support system comprising:
a power tool securably-pairable, extension support system separably itinerant, substantially universal, substantially permanent, specific power tool pedestal configuration set, base assembly;
at least one integral, continuously repositionable, power tool connection system configured integral to said power tool securably-pairable, extension support system separably itinerant, substantially universal, substantially permanent, specific power tool pedestal configuration set, base assembly;
at least one adjustable presettable support height adjustment element attached to said power tool securably-pairable, compact, extension support system separably itinerant, substantially universal base assembly;
at least one extension support at least partially aligning, and power tool connection isolated, attachment element responsive to said at least one adjustable presettable support height adjustment element;
at least one independent, individually base attachable-detachable, extension support configured to be detachably attached to said power tool securably-pairable, compact, extension support system separably itinerant, substantially universal base assembly by said at least one extension support at least partially aligning attachment element.

2. A universal power tool extension support system as described in claim 1 wherein said power tool securably-pairable, extension support system separably itinerant, substantially universal base assembly comprises: a pair of side base rails; and a pair of facing base rails.

3. A universal power tool extension support system as described in claim 1 and further comprising at least one support-independent, self-contained power tool connector.

4. A universal power tool extension support system as described in claim 2 wherein said at least one of said rails comprises at least one extruded rail having at least one top t-slot.

5. A universal power tool extension support system as described in claim 2 wherein said at least one of said rails comprises at least one extruded rail having at least one side t-slot.

6. A universal power tool extension support system as described in claim 2 wherein said each of said rail pairs comprises a pair of extruded rails, each having symmetric side t-slots and having symmetric top and bottom t-slots.

7. A universal power tool extension support system as described in claim 2 wherein said each of said rail pairs comprises top-bottom interchangeable rail pairs.

8. A universal power tool extension support system as described in claim 2 wherein said at least one extension support at least partially aligning, and power tool connection isolated, attachment element comprises a quick attach-detach connection system.

9. A universal power tool extension support system as described in claim 8 wherein said quick attach-detach connection system comprises a T-bolt.

10. A universal power tool extension support system as described in claim 1 wherein said at least one extension support at least partially aligning, and power tool connection isolated, attachment element is integral to said at least one adjustable presettable support height adjustment element.

11. A universal power tool extension support system as described in claim 2 and further comprising a power tool relative-to-said at least one extension support at least partially aligning, and power tool connection isolated, attachment element continuous fore-aft position adjustment system.

12. A universal power tool extension support system as described in claim 1 and further comprising a power tool pedestal attachment point depth adjustment system.

13. (canceled)

14. (canceled)

15. (canceled)

16. (canceled)

17. (canceled)

18. (canceled)

13. A universal power tool extension support system comprising
a power tool securably-pairable, compact, extension support system separably itinerant, substantially universal base assembly;
at least one adjustable presettable support height adjustment element attached to said power tool securably-pairable, compact, extension support system separably itinerant, substantially universal base assembly;
at least one extension support at least partially aligning attachment element responsive to said at least one adjustable presettable support height adjustment element;
at least one independent, individually base attachable-detachable, extension support configured to be detachably attached to said power tool securably-pairable, compact, extension support system separably itinerant, substantially universal base assembly by said at least one extension support at least partially aligning attachment element.

14. A universal power tool extension support system as described in claim 13 wherein said at least one independent, individually base attachable-detachable, extension support comprises at least one interchangeable base attachable-detachable material support wing.

15. A universal power tool extension support system as described in claim 14 wherein said at least one interchangeable base attachable-detachable material support wing comprises a T-slide attachment element.

22. (canceled)

16. A universal power tool accessory mount comprising:
a pair of side base rails;
a pair of facing base rails;
at least one integral, continuously repositionable, power tool connection system configured integral to at least one rail of at least one of said pair of rails;
a substantially universal power tool connection space established by at least one of said pairs of rails and that contains said at least one integral, continuously repositionable, power tool connection system;
at least one support-independent, self-contained power tool connector configured to substantially universally connect a power tool to said at least one integral, continuously repositionable, power tool connection system;
at least one power tool connection isolated accessory mount connected to at least one of said rails.

17. A universal power tool accessory mount as described in claim 16 wherein said at least one of said rails comprises at least one extruded rail having at least one top t-slot.

18. A universal power tool accessory mount as described in claim 16 wherein said at least one of said rails comprises at least one extruded rail having at least one side t-slot.

26. (canceled)

27. (canceled)

19. A universal power tool accessory mount as described in claim further comprising a slide-type connection system comprising a T-bolt.

20. A universal power tool accessory mount as described in claim 16 and further comprising at least one adjustable presettable support height adjustment element.

30. (canceled)

31. (canceled)
